(19) United States
(12) Patent Application Publication
(10) Pub. No.: US 2015/0212684 A1
(43) Pub. Date: Jul. 30, 2015

(54) SYSTEMS AND METHODS FOR SCHEDULING EVENTS WITH GESTURE-BASED INPUT

(71) Applicant: AOL Inc., Dulles, VA (US)

(72) Inventors: James D. Sabia, Warrenton, VA (US); Neal D. Rosen, Arlington, VA (US)

(73) Assignee: AOL Inc., Dulles, VA (US)

(21) Appl. No.: 14/168,727

(22) Filed: Jan. 30, 2014

(51) Int. Cl. G06F 3/0488; H04L 29/08; G06F 3/0482

(52) U.S. Cl. CPC G06F 3/0488; G06F 3/0482; H04L 67/1095

(57) ABSTRACT

Computerized systems and methods are disclosed for scheduling events. In accordance with one implementation, a computerized method comprises receiving an indication of a gesture via a multi-touch display of a computing device, wherein the indication of the gesture comprises data representing a starting location and data representing a directional vector. The method also includes identifying a first graphical object associated with the gesture. In addition, the method includes displaying an event context menu in response to the received gesture and receiving a selection of an event from the event context menu, the selected event corresponding to a second graphical object. The method also includes replacing, on the multi-touch display, the first graphical object with the second graphical object to confirm the event selection.

### BACKGROUND

1. Technical Field

The present disclosure relates generally to computerized systems and methods for scheduling events. More particularly, and without limitation, the present disclosure relates to systems and methods for scheduling, viewing, updating, and managing events with gesture-based input.

2. Background Information

Often people want to schedule events for themselves or a group, for example, their friends or family. Scheduling an event use to require writing down an event in a calendar or appointment book. Today, people use computing devices (such as mobile phones and tablets) to manage their daily activities and scheduled events. Event scheduling, however, can be cumbersome and require a detailed process, which, to date, often involves multiple screens and use of a keyboard for input.

Additionally, users desire more functionality with regard to scheduling events to better streamline appointments, communications, etc. Further, as increasing numbers of people, including business groups, athletic teams, social groups, families and the like, associate and communicate with one another, the need for improved systems and methods for efficiently scheduling events grows.

### SUMMARY

Embodiments of the present disclosure relate to computerized systems and methods for scheduling events. Embodiments of the present disclosure also encompass systems and methods for gestured-based input for scheduling events and manipulating a timeline. Further, some embodiments of the present disclosure relate to systems and methods for updating at least one graphical object associated with a scheduled event.

In accordance with certain embodiments, a computerized method is provided for scheduling events. The method includes receiving an indication of a gesture via a multi-touch display of a computing device, wherein the indication of the gesture comprises data representing a starting location and data representing a directional vector. The method also includes identifying a first graphical object associated with the gesture. Further, the method includes displaying an event context menu in response to the received gesture and receiving a selection of an event from the event context menu, the selected event corresponding to a second graphical object. In addition, the method includes displaying, on the multi-touch display, the second graphical object in place of the first graphical object to confirm the event selection.

In accordance with additional embodiments of the present disclosure, a computer-implemented system is provided for scheduling events. The system may comprise at least one processor and a memory device that stores instructions which, when executed by the at least one processor, causes the at least one processor to perform a plurality of operations, including receiving an indication of a gesture via a multi-touch display of a computing device, wherein the indication of the gesture comprises data representing a starting location and data representing a directional vector. The operations performed by the at least one processor also include identifying a first graphical object associated with the gesture. Further, the operations performed by the at least one processor include displaying an event context menu in response to the received gesture and receiving a selection of an event from the event context menu, the selected event corresponding to a second graphical object. In addition, the operations performed by the at least one processor include displaying, on the multi-touch display, the second graphical object in place of the first graphical object to confirm the event selection.

In accordance with further embodiments of the present disclosure, a computerized method is provided for manipulating a timeline. The method includes displaying, on a multi-touch display, a plurality of content areas, each content area corresponding to a starting graphical object and an associated amount of time. The method also includes receiving an indication of a pinch or spread gesture via the multi-touch display, the indication of the pinch or spread gesture comprising data representing a first location and a first direction, wherein a first set of graphical objects comprises first plural graphical objects fully displayed on the multi-touch display, and wherein a second set of graphical objects comprises second plural graphical objects depicting time not yet displayed on the multi-touch display. Further, the method includes updating the content area corresponding to the starting graphical object to depict the time to display the second set of graphical objects.

In accordance with additional embodiments of the present disclosure, a system is provided for manipulating a timeline. The system may comprise at least one processor and a memory device that stores instructions which, when executed by the at least one processor, causes the at least one processor to perform a plurality of operations, including displaying, on a multi-touch display, a plurality of content areas, each content area corresponding to a starting object and an associated amount of time. Further, the operations performed by the at least one processor may also include receiving an indication of a pinch or spread gesture via the multi-touch display, the indication of the pinch or spread gesture comprising data representing a first location and a first direction, wherein a first set of graphical objects comprises first plural graphical objects fully displayed on the multi-touch display, and wherein a second set of graphical objects comprises second plural graphical objects depicting time not yet displayed on the multi-touch display. The operations performed by the at least one processor also include updating the content area corresponding to the starting graphical object to depict the time to display the second set of graphical objects.

In accordance with further embodiments of the present disclosure, a computerized method is provided for updating a graphical object associated with a scheduled event. The method includes scheduling an event, the event being associated with a start time. The method also includes displaying at least one graphical object corresponding to the event, the at least one graphical object being displayed in at least one color. Further, the method includes updating, progressively, the at least one color of the at least one graphical object as the current time approaches the start time of the scheduled event.

In accordance with additional embodiments of the present disclosure, a system is provided for updating a graphical object associated with a scheduled event. The system includes at least one processor and a memory device that stores instructions which, when executed by the at least one processor, causes the at least one processor to perform a plurality of operations. The operations include scheduling an event, the event being associated with a start time. Further, the operations performed by the at least one processor include displaying at least one graphical object corresponding to the event, the at least one graphical object being displayed in at least one color. The operations performed by the at least one processor also include updating, progressively, the at least one color of the at least one graphical object as the current time approaches the start time of the scheduled event.

In accordance with further embodiments of the present disclosure, a computerized method for is provided for scheduling events with at least one participant. The method includes receiving an indication of a gesture via a multi-touch display of a computing device, wherein the indication of the gesture comprises data representing a starting location and data representing a directional vector. The method also include identifying a first graphical object and the at least one participant associated with the gesture. Further, the method includes displaying an event context menu in response to the received gesture and receiving a selection of an event from the event context menu, the selected event corresponding to a second graphical object. The method also includes displaying, on the multi-touch display, the second graphical object in place of the first graphical object to confirm the event selection. In addition, the method also includes generating a notification for the scheduled event including the at least one participant associated with the gesture.

In accordance with further embodiments of the present disclosure, a system is provided for scheduling events with at least one participant. The system may comprise at least one processor and a memory device that stores instructions which, when executed by the at least one processor, causes the at least one processor to perform a plurality of operations, including receiving an indication of a gesture via a multi-touch display of a computing device, wherein the indication of the gesture comprises data representing a starling location and data representing a directional vector. The operations performed by the at least one processor also include identifying a first graphical object and the at least one participant associated with the gesture. Further, the operations performed by the at least one processor include displaying an event context menu in response to the received gesture and receiving a selection of an event from the event context menu, the selected event corresponding to a second graphical object. The operations performed by the at least one processor also include displaying, on the multi-touch display, the second graphical object in place of the first graphical object to confirm the event selection. In addition, the operations performed by the at least one processor also include generating a notification for the scheduled event including the at least one participant associated with the gesture.

It is to be understood that both the foregoing general description and the following detailed description are exemplary and explanatory only, and are not restrictive of embodiments consistent with the present disclosure. Further, the accompanying drawings, which are incorporated in and constitute a part of this specification, illustrate embodiments of the present disclosure and together with the description, serve to explain principles of the present disclosure.

### BRIEF DESCRIPTION OF THE DRAWINGS

The accompanying drawings, which are incorporated in and constitute a part of this disclosure, illustrate several embodiments and aspects of the present disclosure, and together with the description, serve to explain the principles of the presently disclosed embodiments. In the drawings:

FIG. 1 depicts a block diagram of an exemplary system environment n which embodiments of the present disclosure may be implemented and practiced;

FIG. 2 depicts a flowchart of an exemplary method for scheduling events, consistent with embodiments of the present disclosure;

FIGS. 3A, 3B, 3C, 3D, 3E, and 3F illustrate examples of user interfaces of an exemplary platform application, consistent with disclosed embodiments;

FIG. 4 depicts a flowchart of an exemplary method for manipulating a timeline by gestures, consistent with embodiments of the present disclosure;

FIGS. 5A and 5B illustrate examples of user interfaces of an exemplary platform application, consistent with disclosed embodiments;

FIGS. 6A and 6B illustrate examples of user interfaces of an exemplary platform application, consistent with disclosed embodiments;

FIGS. 7A, 7B, 7C, and 7D illustrate examples of user interfaces associated with rescheduling multiple scheduled events, consistent with disclosed embodiments;

FIG. 8 depicts a block diagram of an exemplary system for detecting gesture inputs, consistent with embodiments of the present disclosure;

FIG. 9 depicts a block diagram of an exemplary system for detecting multi-gesture inputs, consistent with embodiments of the present disclosure;

FIG. 10 depicts a flowchart of an exemplary method for updating graphical objects associated with a scheduled event, consistent with embodiments of the present disclosure; and

FIG. 11 depicts a block diagram of an exemplary computing device in which embodiments of the present disclosure may be practiced and implemented.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limiting of the disclosed embodiments. Instead, the proper scope is defined by the appended claims.

In this application, the use of the singular includes the plural unless specifically stated otherwise. In this application, the use of “or” means “and/or” unless stated otherwise. Furthermore, the use of the term “including.” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

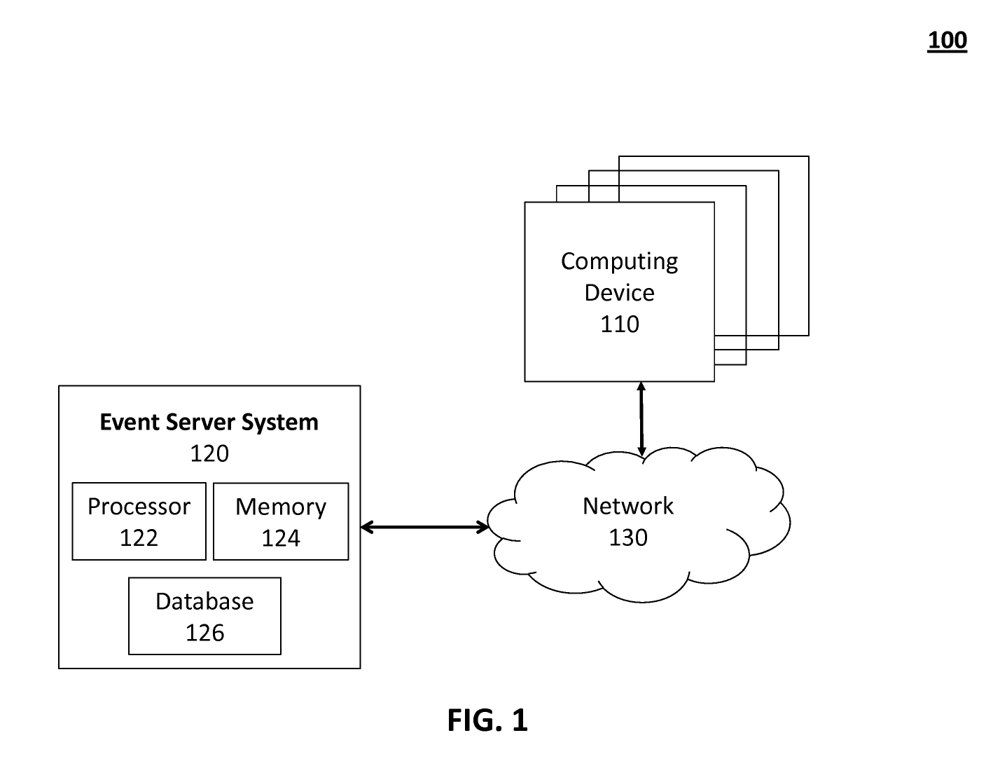

FIG. 1 illustrates an exemplary system environment 100 in which embodiments consistent with the present disclosure may be implemented and practiced. As further disclosed herein, system environment 100 of FIG. 1 may be used for scheduling events, manipulating a timeline, and updating graphical objects associated with events. As will be appreciated, the number and arrangement of components illustrated in FIG. 1 is for purposes of illustration. Embodiments of the present disclosure may be implemented using similar or other arrangements, as well as different quantities of devices and other elements than what is illustrated in FIG. 1.

As shown in FIG. 1, system environment 100 may include one or more computing devices 110 and one or more event server systems 120. All of these components may be disposed for communication with one another via an electronic network 130, which may comprise any form or combination of networks for supporting digital communication, including the Internet. Examples of electronic network 130 include a local area network (LAN), a wireless LAN (e.g., a “WiFi” network), a wireless Metropolitan Area Network (MAN) that connects multiple wireless LANs, a wide area network (WAN) (e.g., the Internet), and/or a dial-up connection (e.g., using a V.90 protocol or a V.92 protocol). In the embodiments described herein, the Internet may include any publicly-accessible network or networks interconnected via one or more communication protocols, including, but not limited to, hypertext transfer protocol (HTTP) and transmission control protocol/internet protocol (TCP/IP). Moreover, electronic network 130 may also include one or more mobile device networks, such as a 4G network, LTE network, GSM network or a PCS network, that allow a computing device or server system, to send and receive data via applicable communications protocols, including those described above.

Computing device 110 may be configured to receive, process, transmit, and display data, including scheduling data. Computing device 110 may also be configured to receive gesture inputs from a user. The gestures may include a predefined set of inputs via a multi-touch display (not illustrated) including, for example, hold, pinch, spread, swipe, scroll, rotate, or drag. In addition, the gestures may include a learned set of moves corresponding to inputs. Gestures may be symbolic. Computing device 110 may capture and generate depth images and a three-dimensional representation of a capture area including, for example, a human target gesturing. Gesture input devices may include stylus, remote controls, visual eye cues, and/or voice guided gestures. In addition, gestures may be inputted by sensory information. For example, computing device 110 may monitor neural sensors of a user and process the information to input the associated gesture from the user's thoughts.

In the exemplary embodiment of FIG. 1, computing device 110 may be implemented as a mobile device or smart-phone. However, as will be appreciated from this disclosure, computing device 110 may be implemented as any other type of computing device, including a personal computer, a laptop, a handheld computer, a tablet, a PDA, and the like,

Computing device 110 may include a multi-touch display (not illustrated). Multi-touch display may be used to receive input gestures from a user of computing device 110. Multi-touch display may be implemented by or with a trackpad and/or mouse capable of receiving multi-touch gestures. Multi-touch display may also be implemented by or with, for example, a liquid crystal display, a light-emitting diode display, a cathode-ray tube, etc.

In still additional embodiments, computing device 110 may include physical input devices (not illustrated), such as a mouse, a keyboard, a trackpad, one or more buttons, a microphone, an eye tracking device, and the like. These physical input devices may be integrated into the computing device 110 or may be connected to the computing device 110, such as an external trackpad. Connections for external devices may be conventional electrical connections that are implemented with wired or wireless arrangements.

In an exemplary embodiment, computing device 110 may be a device that receives, stores, and/or executes applications. Computing device 110 may be configured with storage or a memory device that stores one or more operating systems that perform known operating system functions when executed by one or more processors, such as or more software processes configured to be executed to run an application.

The exemplary system environment 100 of FIG. 1 may include one or more server systems, databases, and/or computing systems configured to receive information from users or entities in a network, process the information, and communicate the information with other users or entities in the network. In certain embodiments, the system 100 of FIG. 1 may be configured to receive data over an electronic network 130, such as the Internet, process/analyze the data, and provide the data to one or more applications. For example, in one embodiment, the system 100 of FIG. 1 may operate and/or interact with one or more host servers, one or more user devices, and/or one or more repositories, for the purpose of associating all data elements and integrating them into, for example, messaging, scheduling, and/or advertising systems.

Although system environment 100 is illustrated in FIG. 1 with a plurality of computing devices 110 in communication with event server system 120 via network 130, persons of ordinary skill in the art will recognize from this disclosure that system environment 100 may include any number of number of mobile or stationary computing devices, and any additional number of computers, systems, or servers without departing from the spirit or scope of the disclosed embodiments. Further, although computing environment 100 is illustrated in FIG. 1 with a single event server system 120, persons of ordinary skill in the art will recognize from this disclosure that system environment 100 may include any number and combination of event servers, as well as any number of additional components including data repositories, computers, systems, servers, and server farms, without departing from the spirit or scope of the disclosed embodiments.

The various components of the system of FIG. 1 may include an assembly of hardware, software, and/or firmware, including memory, a central processing unit (“CPU”), and/or a user interface. For example, with respect to event server system 120, memory 124 may include any type of RAM or ROM embodied in a physical storage medium, such as magnetic storage including floppy disk, hard disk, or magnetic tape; semiconductor storage such as solid state disk (“SSD”) or flash memory; optical disc storage; or magneto-optical disc storage. A CPU of event server system 120 may include one or more processors 122 for processing data according to a set of programmable instructions or software stored in memory. The functions of each processor may be provided by a single dedicated processor or by a plurality of processors. Moreover, processors may include any type or combination of input/output devices, such as a display monitor, keyboard, touch screen, and/or mouse. Furthermore, event server system 130 may be implemented using one or more technologies such as JAVA, Apache/Tomcat, Bus Architecture (RabbitMQ), MonoDB, SOLR, GridFS, Jepetto, etc.

As further shown in FIG. 1, one or more databases (“data repositories”) 126 may be provided that store data collected about each user, including the user's contacts, appointments, recurring events, or meetings. Database 126 may be part of event server system 120 and/or provided separately within system environment 100. Event server system 120 and/or system environment 100 may also include a data store (not illustrated) for storing the software and/or instructions to be executed by one or more processors.

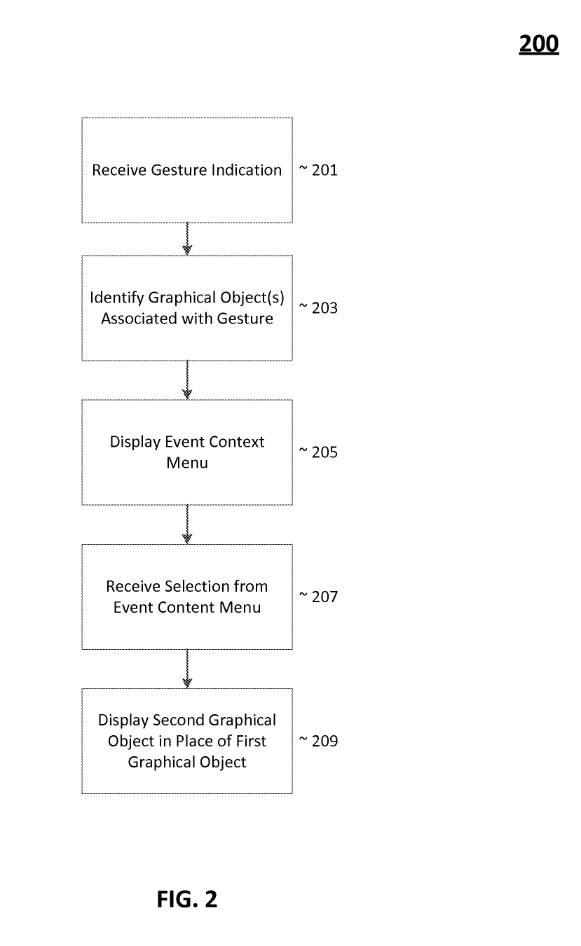

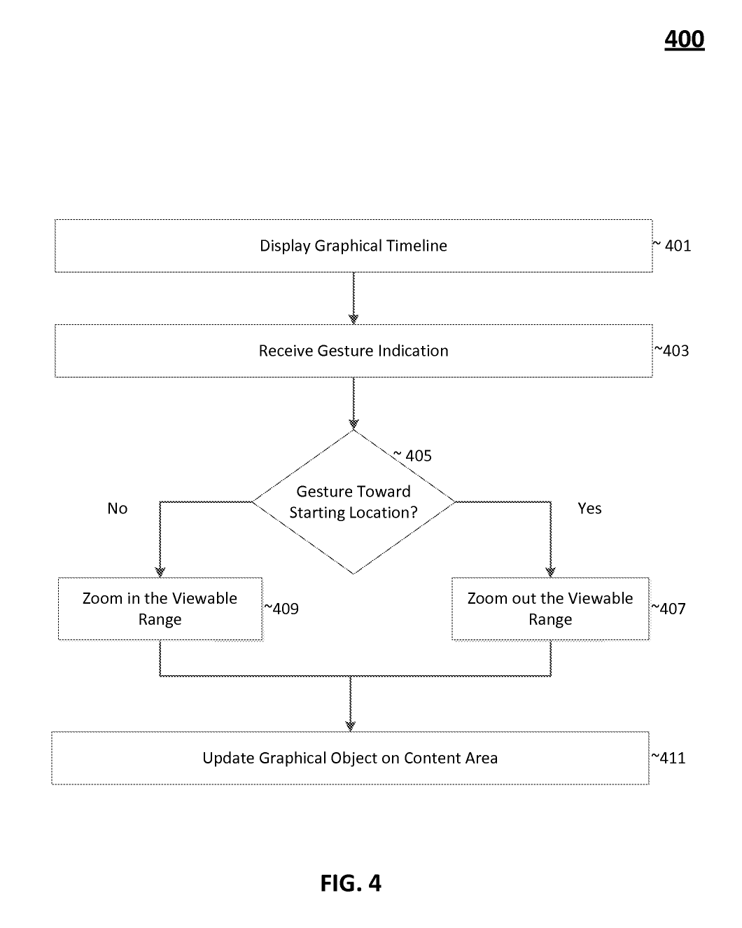

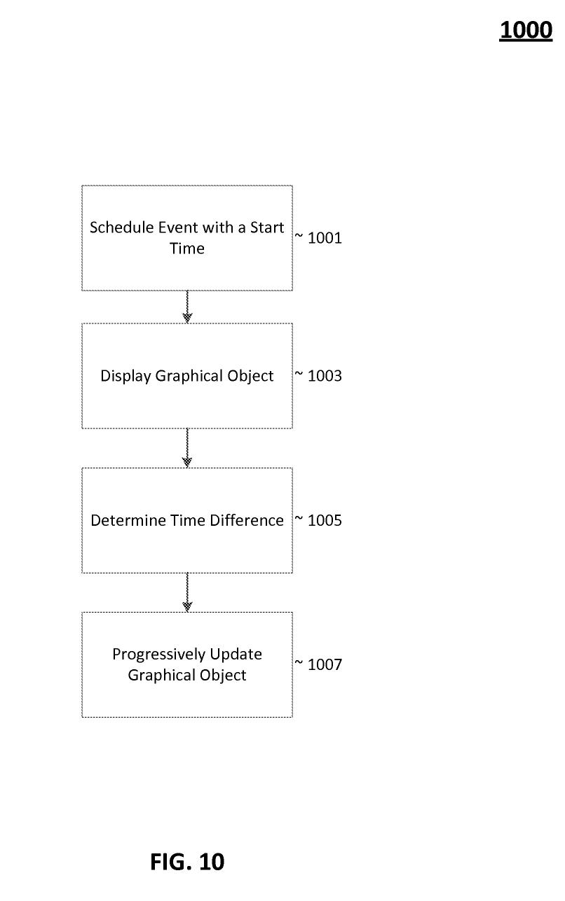

The above system, components, and software associated with FIG. 1 may be used to implement various methods and processes consistent with the present disclosure, such as the exemplary process illustrated in FIG. 2, FIG. 4, and FIG. 10. In addition, as will be appreciated from this disclosure, the above system, components, and software may be used to implement the methods, graphical user interfaces, and features described below.

FIG. 2 illustrates a flow chart of an exemplary process 200 for scheduling events, consistent with embodiments of the present disclosure. In some embodiments, as described below, computing device 110 may execute software instructions to perform process 200 to schedule events using gesture inputs. The number and arrangement of steps in FIG. 2 is for purposes of illustration. As will be appreciated from this disclosure, the steps may be combined or otherwise modified, and additional arrangements of steps may be provided to implement process 200.

As part of process 200, computing device 110 may receive at least one gesture from a user (step 201). This may be performed by detecting n-contacts with the display surface. Once a contact is detected the number of contacts, for example, the number of fingers in contact with the display surface may be determined. In various embodiments, gesture inputs do not require contact with the display. For example, a user may swipe in mid-air to input a gesture. The received indication may include data representing a starting location. In one embodiment, the starting location may correspond to a single contact on the display surface. For example, a single finger in contact with the display. In another embodiment, there may be n starting locations corresponding to the n-contacts. For example, n-fingers having contacted the display 120. The received indication may also include data representing a directional vector. The directional vector may correspond to a type of motion, such as a rotating, twisting, swiping, pinching, spreading, holding, or dragging gesture. In additional embodiments, a directional vector may not exist. For example, the gesture has no motion associated. When a directional vector does not exist it may be determined the gesture corresponds to a press and hold or tap. In another embodiment, the directional vector may correspond to the starting location for gestures without motion.

The received indication may include data representing a start and end time. For example, if a user wishes to schedule an event from 5 p.m. to 6 p.m., the received indication data may contain 5 p.m. as a start time and 6 p.m. as the end time. In further embodiments, the received indication data may contain information related to a plurality of users when the proposed scheduled event corresponds to a plurality of users, such as their names, location, and photo. However, it should be understood that this data might include more information or less information.

Computing device 110 may receive the orientation of the device from the operating system. In another embodiment, the orientation of computing device 110 may be determined and the correlating direction vector for the input gesture may also be determined based on the orientation of the computing device. For example, if computing device 110 is vertical in orientation and receives a gesture from the left side of the display to the right side of the display, then the determined direction of the vector may correspond to a swipe gesture from left to right. As a further example, if computing device 110 is horizontal in orientation and the same start and end position is used, then it may be determined that the gesture corresponds to a swipe gesture from top to bottom of the display.

When a gesture indication is received, computing device 110 may identify at least one graphical object associated with the gesture (step 203). In one embodiment, the identification of at least one graphical object may be based on the use of coordinates to identify where the graphical objects are in relation to the display. In another embodiment, the determination of at least one graphical object associated with a gesture may be calculated using the starting location data and the directional vector data. For example, if computing device 110 receives a swipe gesture from left to right, computing device 110 may determine the number of graphical objects associated with the gesture using a formula to determine the number and position of objects between the starting location and the directional vector end location. Display 820 may be divided into sections, computing device 810 may obtain the contact positions associated with each section and calculate, for example, the spread distance between the contact points for each section. In another embodiment, the graphical objects may be along a directional vector corresponding to n-contact points with n-starting locations. For example, two fingers may contact the display each having a starting location along the y-axis and the system receives a swipe gesture computing device 110 may determine n-graphical objects along the two finger gesture and store the received data in memory. In a further embodiment, the first graphical objects may have configured locations on the display and the directional vector data may be matched to the configured location of the first graphical objects.

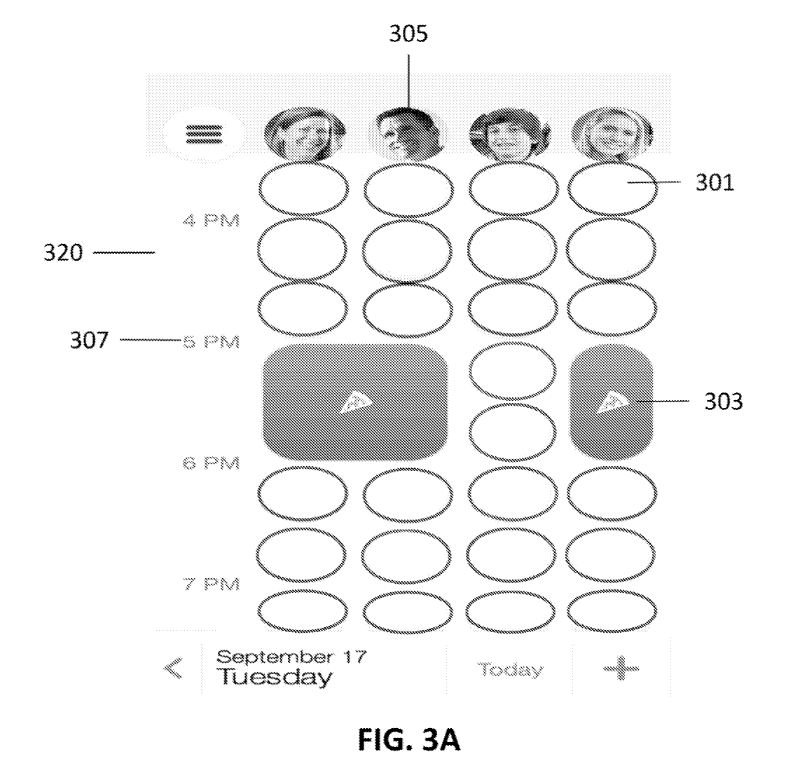

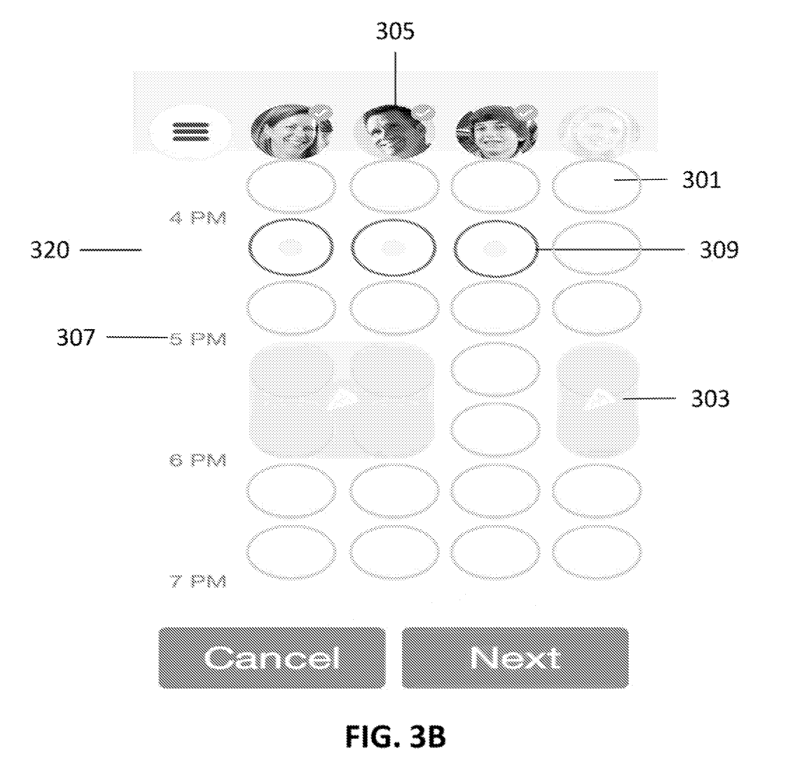

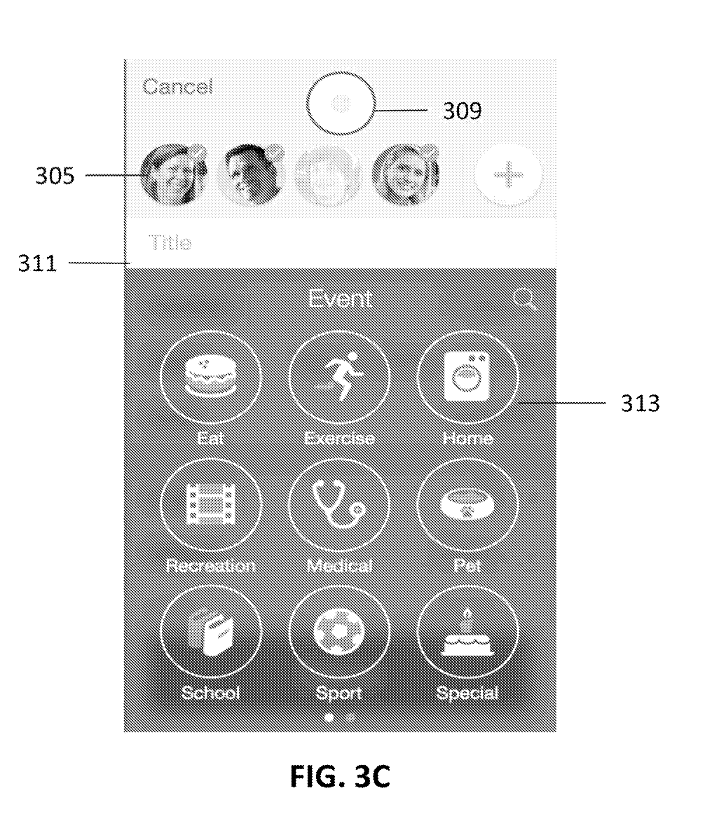

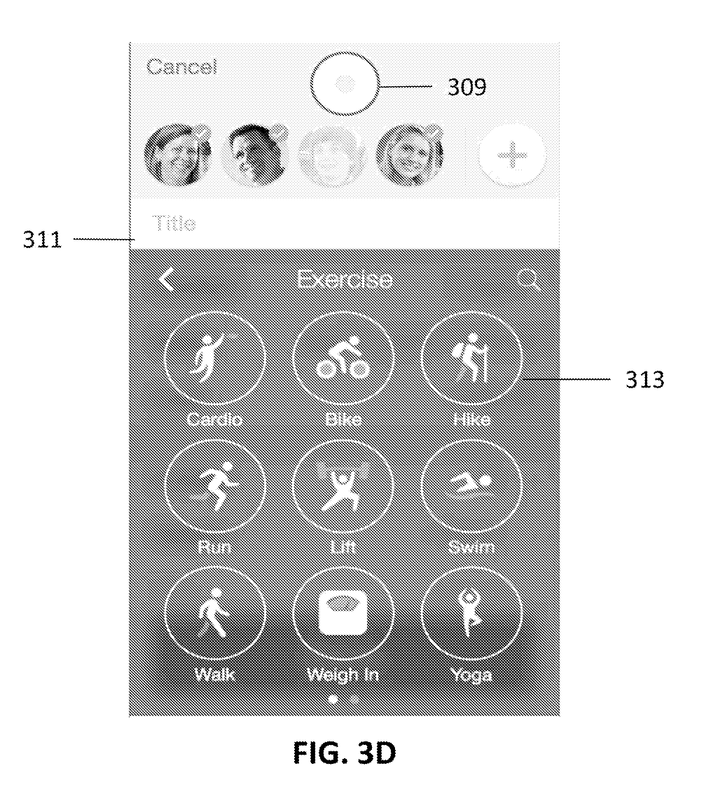

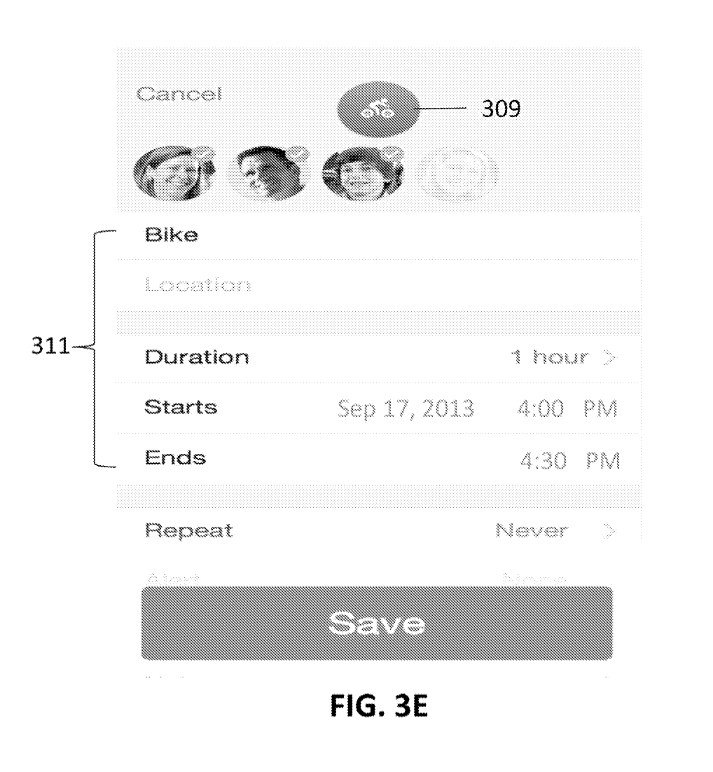

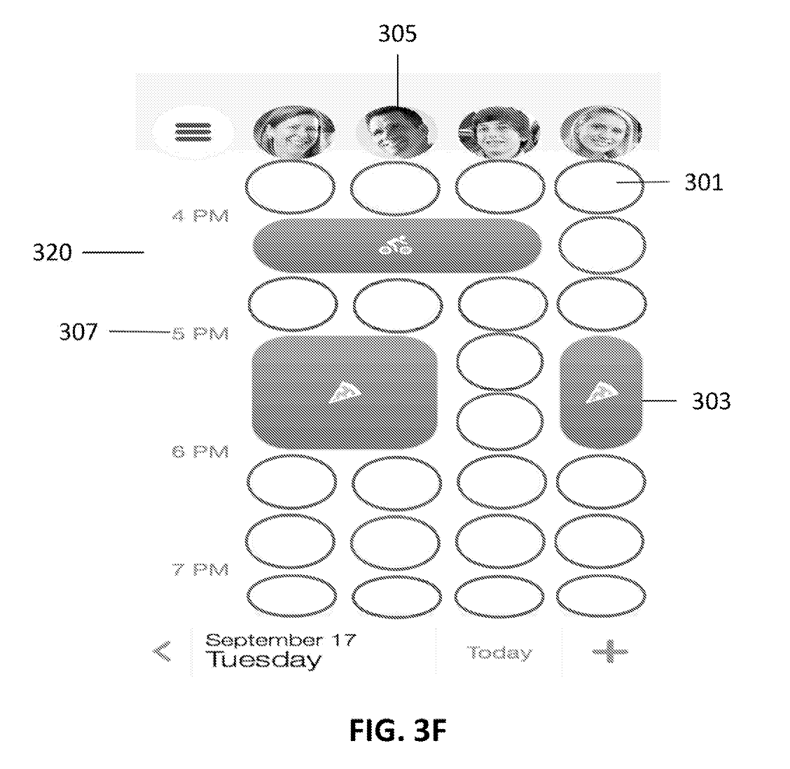

In some embodiments, when a gesture is received, computing device 110 may identify at least one participant associated with the gesture. Each identified participant may be confirmed to the user or creator of the event. For example, FIG. 3A shows Mom, Dad, and Son associated with the gesture are identified as participants by checking their pictures and dimming the Daughter. Additionally, computing device 110 may generate a notification to each of the participants. For example, the event details may be sent to each of the participants over the network. The participants may respond to the event, with each response being communicated back to the creator of the event.

Computing device 110 may determine the receive indication does not have a motion associated with the gesture; however, if the gesture exceeds a threshold time it may be determined the gesture is associated with a press and hold. In one embodiment, the threshold time is fixed or predetermined. For example, the threshold time may be fixed to 0.2 seconds. In another embodiment, the threshold time is configurable by the application or user. For example, the threshold may have a default value of at least 0.2 seconds; however, the application or user may configure the threshold time to 0.5 seconds. For example, where the application has set the threshold time to be at least 0.5 seconds, computing device 110 would execute the associated command for a press and hold gesture when the contact has been determined to exceed 0.5 seconds. In a further embodiment, if motion is not detected then a command is selected based on the number of contacts only and performed on the at least one associated graphical object (step 205) associated with that gesture. In a further embodiment, where the gesture has no motion and does not exceed a minimum threshold, it may be determined the gesture is a tap.

In various embodiments, an event context menu may be displayed in response to a received gesture (step 205). In certain embodiments in which the event context menu is displayed the context menu may be overlaid over the first graphical objects. For example, a menu allowing a user to select an event type may be overlaid in front the original screen where the gesture was initiated. In another example, the first graphical objects are dimmed behind the displayed context menu. The context menu may contain n-submenus. In some embodiments, the context menu is n-levels deep. The context menu may contain a plurality of graphical objects corresponding to events. Each graphical object may have an associated name. For example, a menu is displayed with graphical objects corresponding to exercise. The sub menu under exercise may contain another set of graphical objects such as Cardio, Bike, Hike, etc. Each event may have a corresponding graphical object associated with the event.

In certain embodiments, the displayed context menu may be uniquely associated with the type of gesture. For example, a press and hold gesture may result in a unique context menu than a swipe gesture. Where the context menu is activated by a gesture on a scheduled event the context menu may contain information associated with the scheduled event. Such information may include, for example, the people scheduled to participate in the event, the time, date, alert time, location. In another embodiment, the context menu may allow the users to chat with other members scheduled to participate in the event. The display context menu associated with a scheduled event may display the location of the event on a map and each user's location on the map in relationship to the scheduled event's location. In addition, similar locations may be displayed on the map along with user favorite locations in proximity to the user or event location. Recommendations may be displayed from saved favorites or locations corresponding to the event. Further, the display context menu associated with a scheduled event may allow the event to be deleted.

Computing device 110 may receive a selected event for scheduling. For example, a user may select dinner. In one embodiment, the event may have an associated second graphical object. Continuing with the dinner example, the user may select an event associated with dinner, for example, pizza. The second graphical object may be displayed in place of the first graphical object to confirm the scheduled event (step 209). For example, a graphical object associated with pizza event may replace the first graphical object corresponding to the start and end time in the received data. Alternatively, the second graphical object may be displayed over the first graphical object in step 209. For example, a graphical object associated with pizza event may be overlayed on top of the first graphical object corresponding to the start and end time in the received data.

FIG. 3A, 3B, 3C, 3D, 3E, and 3F illustrate examples of user interfaces of an exemplary platform application, consistent with disclosed embodiments. In some embodiments, the exemplary platform application is executed on computing device 110. In other embodiments, the exemplary platform application is executed on server system 120 and data inputs and outputs related to the application are provided via computing device 110 that is in communication with server system 120,

As shown in FIG, 3A, first graphical object 301 corresponds to a time on display 320. Further, as depicted in FIG. 3A, second graphical object 303 replaced first graphical object 301 for a plurality of users. In this example, the pizza icon corresponds to a confirmed event for dinner between Mom, Dad, and Daughter. Display 320 shows timeline 307 in half-hour blocks with hour indicators. In another embodiment, the application and/or user may adjust timeline 307 to display in smaller or larger increments of time. For example, a user may choose to display timeline 307 in 15 minute increments to show a more granular schedule. In another example, the timeline may display the days of the week, weeks in the month, or months in the year.

Along the top of the display, a graphical object 305 may represent each member whose time is capable of being scheduled. The graphical object may correspond to a column or row associated with that member's schedule. In one embodiment, the user may configure members of a group. In some embodiments, numerous groups are capable of existing simultaneously. When a user opens their calendar application, for example, the user may be prompted to create one or more groups. A default graphical object may be assigned to each newly created member or the user may assign a custom graphical object associated with that member. The user may select contacts from an address book, friends from social networks, or members from a photograph. For example, computing device 110 may use facial recognition when the user selects a photo. Computing device 110 may detect the faces in the photo and may create graphical objects and associate the face with a member profile. Once the faces are selected other identifying information may be entered. In various embodiments, when the member corresponds to an individual in an address book or social network the member fields may be populated for the user. The user may also select a graphical object to correspond to each member of the group. Group members may be created by the user or from pre-existing groups on event server 120 in FIG, 1. A pre-existing group, for example, may correspond to an e-mail listserv.

As shown in FIG. 3B, in one embodiment a gesture is displayed with a starting location at 4 p.m. under the Mom. It may be further determined that a plurality of first graphical objects 309 may be identified as being associated with the received gesture. The received gesture may be determined to be a swipe gesture with a directional vector from left to right ending with the Son. In another embodiment, the gesture may be determined to be a press and hold gesture. For example, a user makes contact with 3 fingers, underneath the Mom, Dad, and Son, exceeding a minimum threshold time. In another embodiment, a user makes a swipe gesture in air and the computing device captures the gesture via a gesture capture unit (not pictured in FIG. 3B).

FIG. 3C shows, for example, a context menu that may be displayed in response to a received gesture. The context menu may be overlaid over the screen where the gesture was initiated. In another embodiment, the context menu may generate a new window to be displayed. For example, the context menu may replace the previous screen. In the case where the context menu is overlaid the display where the gesture was initiated may be dimmed in the background. For example, FIG. 3B depicts the dimmed state of the display where the gesture was initiated prior to the context menu being displayed. FIG. 3C further depicts the context menu overlaid over the dimmed display in FIG. 3B. A user may initially use a gesture to schedule an event between, for example, Mom. Dad, and the Son. In response to the gesture a context menu depicted in FIG. 3C may be displayed to the user. The user may wish to change the participating members. In one embodiment, the application may receive a gesture, for example, a selection on graphical object 305 selecting the members of the group the user wishes to participate. In this example, the user changed the original members from the received gesture Mom, Dad, and Son to Mom, Dad, and Daughter. The application may dim members of the group who are not selected as participating members. For example, in FIG. 3C the Son is dimmed because the Son is not a participating member for this event. Additionally, a check mark or other identifying object may be displayed with the graphical object to indicate selected members.

Continuing with FIG. 3C, in one embodiment, the user is presented with an event selection context menu in response to the gesture. From the event selection menu, the user may select a second graphical object 313 associated with to the event. For example, the user may select Exercise from the event selection menu. The event selection menu maybe n-pages long. The menu may be scrollable displaying a plurality of pages with more events for the user to select. In another embodiment, a user may search for an event. For example, a user may type “Birthday” into a search bar. In a further embodiment, the event context menu may have a plurality of sub-menus. An example of a sub-menu is depicted in FIG. 3D.

Each sub-menu may contain a plurality of second graphical objects 313 associated with its parent menu. For example, under the Exercise parent folder the sub-menu may contain and display graphical object associated with Cardio, Bike, Hike, Run, Lift, Swim, Walk, Weigh In, and Yoga events. The sub-menus may have a plurality of second graphical objects 313. The plurality of second graphical objects 313 may not be displayed initialing however, a user may allow page through to display the plurality of second graphical objects 313 not displayed.

Once a user has made a selection of an event a new context menu may be displayed to the user. In one embodiment, the user may again change the selection of participating members. For example, FIG. 3E displays the user removing the Daughter and adding the Son back to the event. The name associated with the selected event, the corresponding graphical object, and a plurality of fields 311 may be populated with the information. The selected event's corresponding graphical object 313, for example, Bike may replace the first graphical object 309. Fields 311 may be updated with the start time, end time, event name, and the duration. In another embodiment, the location may be populated. For example, a user may configure locations associated with events such as the gym they attend. When the user selects Gym as an event, the location may be populated. In another embodiment, the selected event may generate recommendations on associated locations near the user. These recommendations may be based on saved favorites, top recommender, top recommended places, frequently visited locations, or locations near the user and corresponding with the event type.

The selected graphical object may replace the top-level menu graphical object. Each time the user selects an event the selected event may be tracked. The tracked selections may be used for creating favorite events or targeted advertisements. In some embodiments, advertisements related to the event selection by the user or the profile(s) of members in the group may be presented to the user.

The confirmed event may be displayed to the user as a single graphical object. For example, Pizza graphical object under the daughter in FIG. 3A. The system may determine if a plurality of graphical objects are associated with the gesture. If a plurality of graphical objects are determined to be associated with the gesture it may further determined the plurality of graphical objects associated with the gesture are adjacent. As a result of the determination, the system may determining a size for the second graphical object and replace the adjacent plurality of first graphical objects with a single second graphical object. For example, FIG. 3F depicts a bike icon the size necessary to replace three (3) first graphical objects. In another embodiment, a plurality of second graphical objects may replace the plurality of first graphical objects. In another embodiment, the second graphical object may be a combination of second graphical objects. For example, the first pizza icon corresponds to a size to replace a plurality of adjacent graphical objects in combination with a second graphical object replacing a first graphical object.

A schedule request may be created that includes a set of details for the event. The schedule request may be, for example, an HTTP (hypertext transfer protocol) request that includes the set of details for the event. The set of details may include information such as date, time, location, etc. for the event. The schedule request may also include an identifier of the event and an identifier of the event creator. In order to create the schedule request, the event details are parsed using parsing methods known in the art. The schedule request including the set of details may be sent to a server (e.g., server system 120) that stores or has access to the invitee's calendar and calendar data, as well as the calendar and calendar data for the event creator. The server system may send the schedule request to the selected group members. For example, Mom schedules dinner with Dad. Dad receives a schedule invite including event details from the server system. The server system may store, for example, in a database, recurring appointments, or scheduled events.

FIG. 4 illustrates an exemplary process 400 for manipulating a timeline by gestures, consistent with embodiments of the present disclosure. The number and arrangement of steps in FIG. 4 is for purposes of illustration. As will be appreciated from this disclosure, the steps may be combined or otherwise modified, and additional arrangements of steps may be provided to implement process 400.

As shown in FIG. 4, process 400 may display a timeline to the display (step 401). The timeline may consist of a plurality of contact areas each content area may be associated with an amount of time. For example, a calendar displaying the days of the week. The content area may correspond to a first set of graphical objects. Continuing with the days of the week example Monday, Tuesday, Wednesday, Thursday, Friday, Saturday, and Sunday may be displayed. In one embodiment, an indication of a gesture may be received (step 403). The gesture may be associated with a pinch gesture or a spread/anti-pinch gesture. In one embodiment, the gesture indication includes data representing a first location and a first direction. In another embodiment, the gesture indication includes data representing a plurality of starting locations and a plurality of first directions. For example, a user places two fingers on the display and each finger has its own starting location. The user may move both fingers toward one another indicative of a pinch gesture or the user may only move one finger towards the other finger.

In one embodiment, process 400 may determine whether the gesture is towards the starting location (step 405). One way it may be determined that the gesture is a pinch gesture is, for example, determining whether at least one contact has a directional vector toward the starting point associated with the contact. Another way it may be determined that the gesture is a pinch gesture is to determine the area covered on the display decreases. In a further embodiment, the gesture may be associated with a pinch where it is determined the amount of area between a plurality of first locations is less than the original area between the first locations. Conversely, determining whether a gesture is associated with a spread/anti-pinch gesture may encompass the opposites of the describe methods for determining whether the gesture is associated with a pinch. For example, a user could place two fingers on the display and move the fingers away from one another. The area between the fingers' starting locations and end location may be greater than the starting area between the fingers. Where it is determine the gesture is associated with a pinch the viewable range may be decreased (step 407). Where it is determine the gesture is associated with a spread/anti-pinch gesture the viewable range may increase (step 409). A pinch gesture may be used to condense a displayed object on the display where a spread/anti-pinch gesture may be used to expand a displayed object for display. Pinch and spread/anti-pinch gestures may also semantically zoom through different levels of graphical objects not yet displayed. For example, continuing with the days of the week example above, where a user performs a spread gesture on the graphical object corresponding to Monday the graphical object may be updated to display the hours of the day associated with Monday. In one embodiment, the display automatically displays the closest hour to the current time. In another embodiment, the start time displayed may be set as a default. For example, when viewing by hours within the day the timeline always begins at 8 a.m.

Process 400 may update the content area to depict the time to display corresponding to a second set of graphical objects (step 411). In one embodiment, the updated content area is simultaneously displayed with the gesture input. For example, continuing with the days of the week example, where the user performs a spread gesture on Monday the display may be updated to display the hours of the day for Monday. The display may show scheduled events scheduled for Monday. If the user continues to perform a spread gesture, the display may continue to update and replace the first set of graphical objects with a set of second graphical objects not yet displayed. The user may continually zoom the timeline, for example, from a day view to 15-minute interval view of a single day.

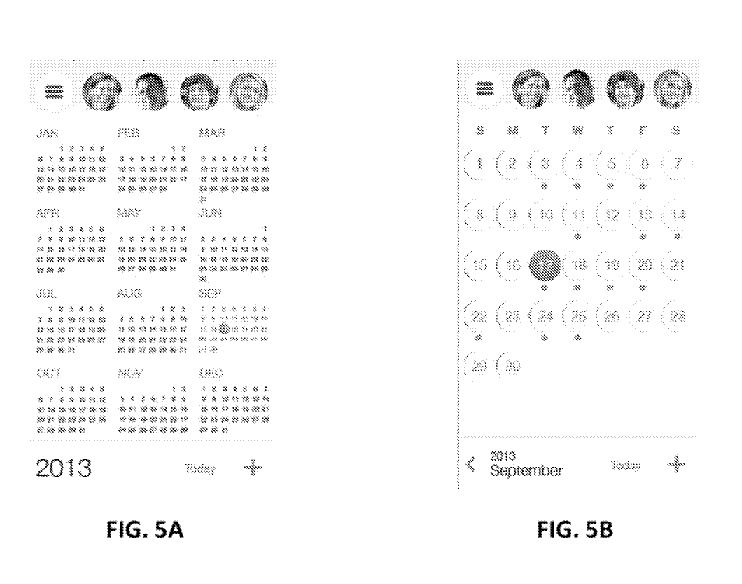

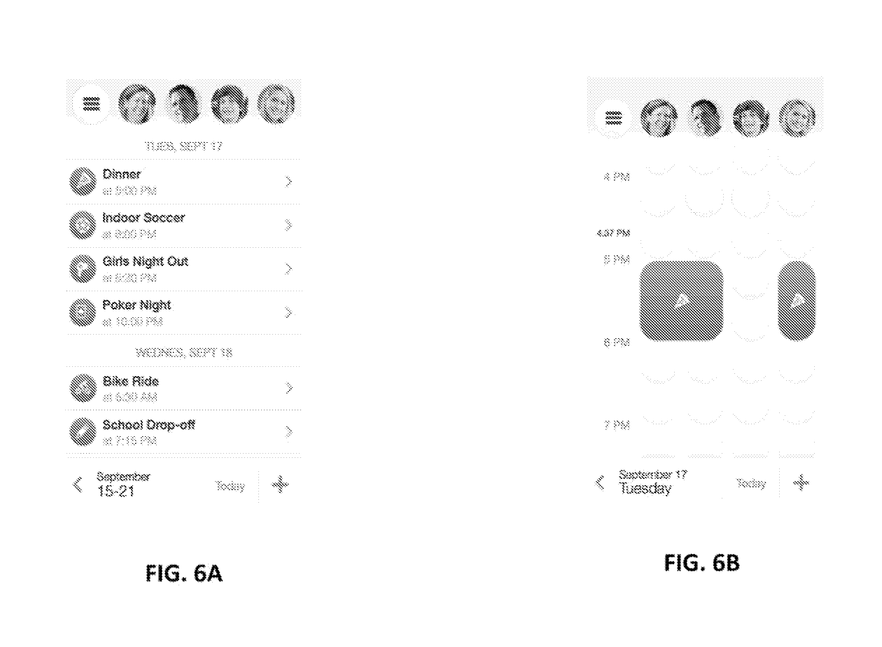

FIGS. 5A and 5B illustrate examples of user interfaces of an exemplary platform application, consistent with disclosed embodiments. FIG. 5A depicts a year view for a calendar. As the user executes, for example, a spread gesture the display may be updated to display the month view depicted in FIG. 5B. The calendar displays scheduled events for the plurality of members. As the user continually performs a spread gesture the second graphical object may replace the first graphical object. For example, FIGS. 6A and 6B are representative of the second graphical objects not yet displayed in FIGS. 5A and 5B. FIG. 6A shows the week view, for example, after a spread gesture from FIG. 5B. As the user continues performing the spread gesture the display may be updated to show the day view in FIG. 6B. In various embodiments, the timeline granularity is configurable. For example, a user may configure the smallest unit of time to correspond with 30-minute intervals or with hour intervals.

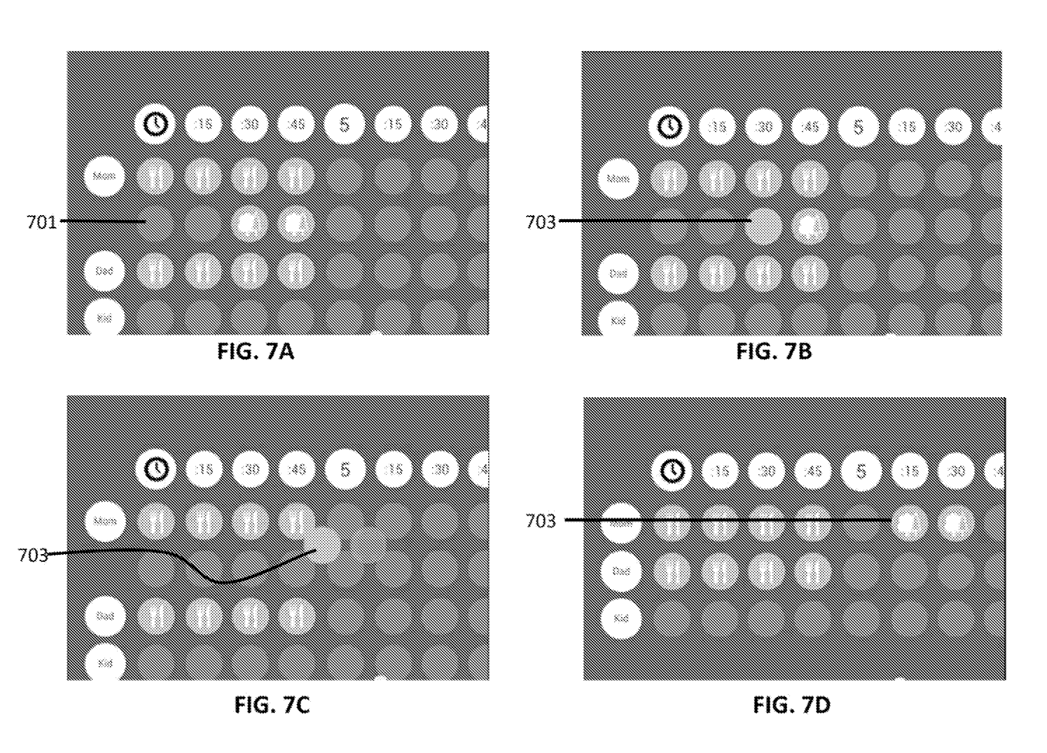

FIGS. 7A, 7B, 7C, and 7D illustrate examples of user interfaces associated with rescheduling multiple scheduled events, consistent with disclosed embodiments. FIG. 7A shows a case where a user has conflicting scheduled events. For example, the Son scheduled Mom to walk the dog at 4:30 p.m.; however, Mom has a scheduled dinner event with Dad. In one embodiment, a second row 701 may be created to display the conflicting event associated with the user, as illustrated in FIG. 7A. If Mom wants to manage her conflicts, she can reschedule the conflicting event or assign the conflicting event to another member in the group. Mom may press and hold the graphical object 703 for the event she wishes to reschedule, as shown in FIG. 7B. It may be determined the gesture is associated with a scheduled event and that the received gesture has exceeded a minimum threshold. Where it is determined that the received gesture corresponds to both a scheduled event and that the gesture exceeds the minimum threshold, the graphical object may be enabled to receive gesture input. The graphical object may be highlighted, change colors, or otherwise provide an indication that the graphical object is ready 703 to receive further input. Mom may drag the graphical object 703 (see FIG. 7C) to a time not conflicting with a previous scheduled event, such as 5:15 p.m. as depicted in FIG. 7D. The additional row associated with the conflicting event may then be replaced or dismissed (see FIG. 7D). In the case where it is determined that the received gesture is associated with a scheduled event but does not exceed a minimum threshold, a context menu may be displayed to the user. In some embodiments, Mom taps on the conflicting scheduled event and a menu displaying a plurality of fields may be displayed to Mom. Such fields may include information related to the event, for example, a start time, end time, duration, name, and location (i.e., “similar to that shown in FIG. 3E”). In addition, a graphical object depicting the participants for the event may be displayed on the display. Alternatively, a list of participates may be displayed. From this context menu, Mom may change the start and end time. Mom may also reassign the event to another member in the group. For example, Mom may select the Daughter. The conflicting event would move from under Mom's column of events to the Daughter's events. Mom may also delete the conflicting event or any other event scheduled.

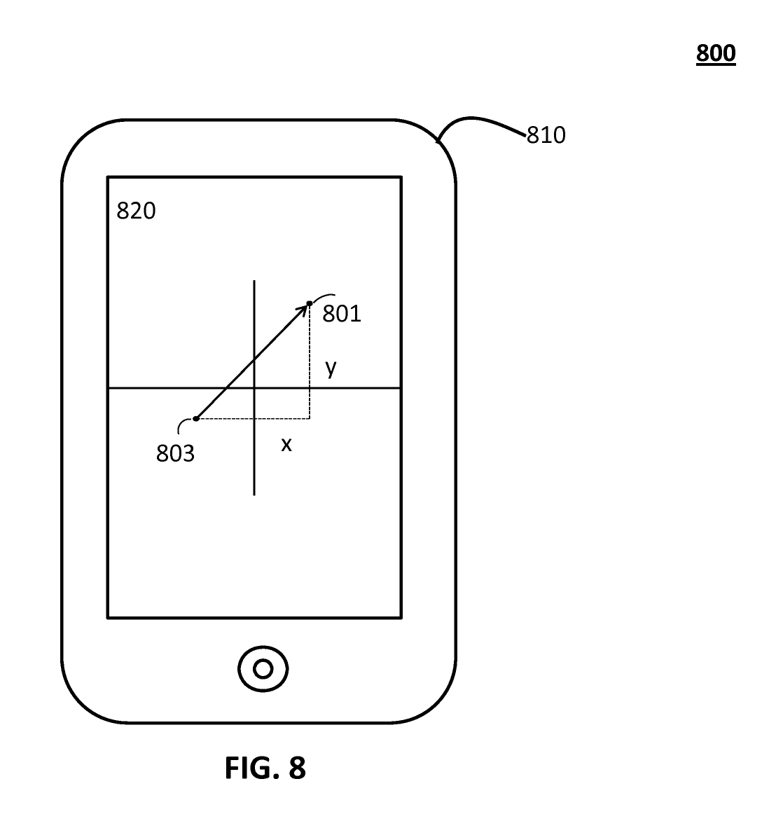

FIG. 8, depicts a block diagram 800 of a computing device 810 with a display 820 for entering gesture inputs. First starting location 801 may have a corresponding set of coordinates (x₁, yᵢ) associated with its position. Second starting location 803 may have a corresponding set of coordinates (x₂, y₂) associated with its position. First starting position and second starting position may correspond to inputs by a user of computing device 810. First starting location 801 and second starting location 803 may correspond to a user places two fingers on display 820. In one embodiment, the starting points may be associated with an input device, such as stylus, air gestures, eye recognition, or monitoring sensory information. In one embodiment, it may be determined that second starting location 803 has a directional vector towards first starting point 801. In another embodiment, the first starting location 801 and second starting location 803 may be used to determine the gesture type. In a further embodiment, first starting location 801 and second starting location 803 may be used to determine the associated first graphical objects.

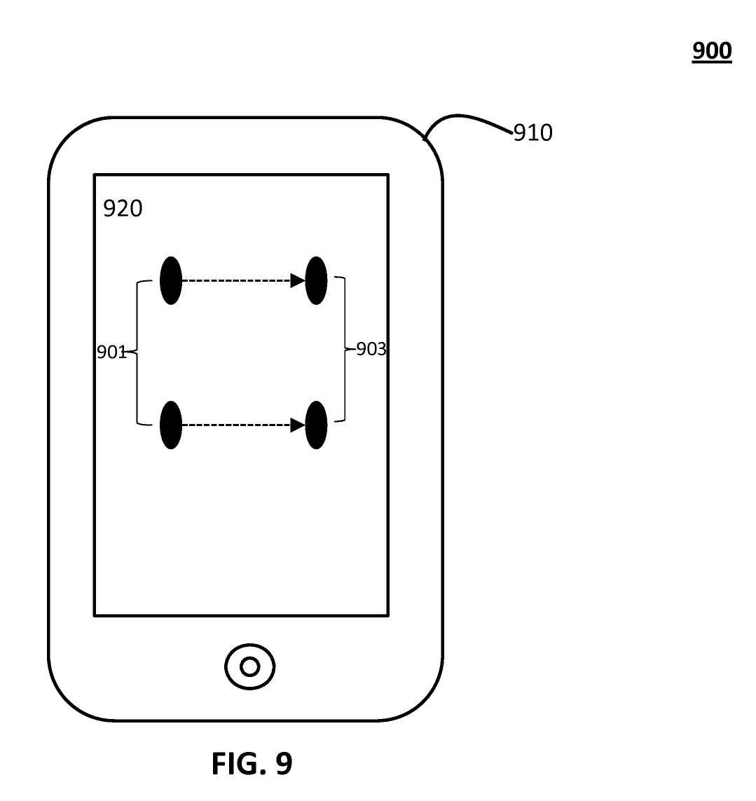

FIG. 9 depicts a block diagram 900 of a computing device 910 with an exemplary multi-touch gesture provided as input to a display 920 using starting locations 901. The user may execute a gesture, contacting the display 920, from left to right with directional vector end points 903. In another embodiment, a user may perform gestures corresponding to multi-touch gestures without making contact with display 920. For example, a user may use two hands and gesture in mid-air. The gesture may be captured by a gesture recognition device (not pictured) and translated as inputs to the computing device.

FIG. 10 depicts a flowchart of an exemplary process 1000 for updating graphical objects associated with a scheduled event, consistent with embodiments of the present disclosure. The number and arrangement of steps in FIG. 10 is for purposes of illustration. As will be appreciated from this disclosure, the steps may be combined or otherwise modified, and additional arrangements of steps may be provided to implement process 1000.

As shown in FIG. 10, process 1000 may begin by a user scheduling an event, wherein the scheduled event has a starting time (step 1001). The schedule event may have an associated graphical object. In step 1003, at least one graphical object may be displayed that corresponds to the event. The graphical object may be comprised of at least one color. For example, the pizza icons in FIG. 3F may be blue. In another example, the icon may be a photo. The photo may be black and white or in color. Process 1000 may dim the graphical object or place a shadow over the graphical object. Process 1000 may further determine the amount of time between the current time and the start time of the event (step 1005). As the time difference between the current time and the start time for the event shortens process 1000 may update, progressively, the at least one color of the at least one graphical object (step 1007).

In some embodiments, the progressive update of the at least one graphical object may result from brightening the graphical objects, changing the transparency of the graphical object, or changing the overlaid shadow. In additional embodiments, the progressive update may include updating the graphical object by changing the color of the graphical objects as the start time approaches.

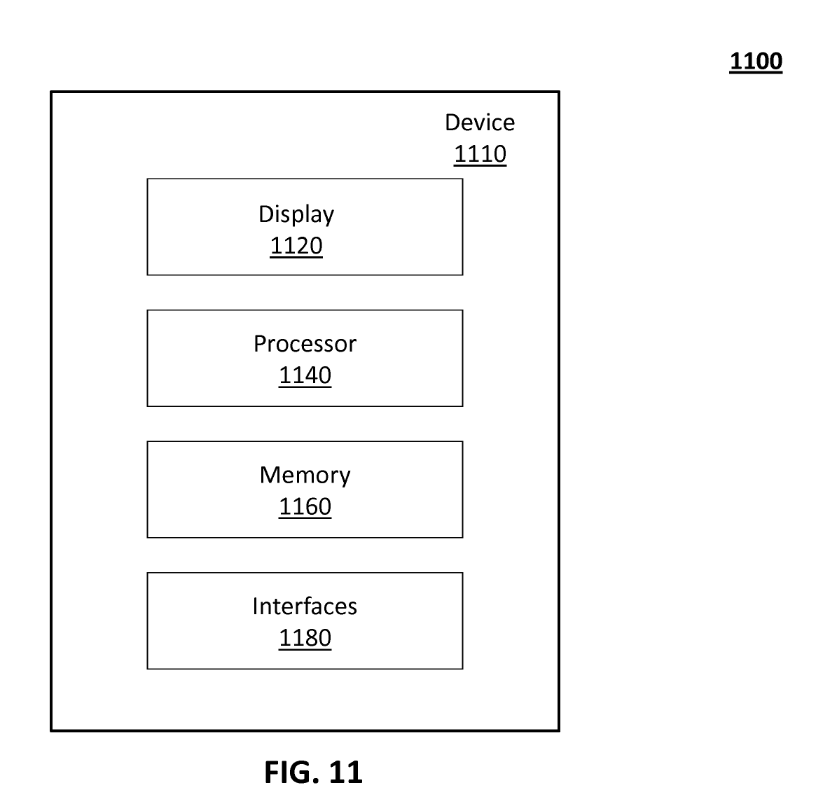

FIG. 11 depicts a block diagram of an exemplary computing device 1100, consistent with embodiments of the present disclosure. Computing device 1100 may be used to implement the components of FIG. 1, such as computing device 110 or server system 120. The number and arrangement of components in FIG. 11 are for purposes of illustration. As will be appreciated from this disclosure, alternative sets of components and arrangements may be used to implement computing device 1100.

As shown in FIG. 11, computing device 1100 may include a memory 1160. Memory 1160 may include one or more storage devices configured to store instructions used by processor 1140 to perform functions related to disclosed embodiments. For example, memory 1160 may be configured with one or more software instructions that may perform one or more operations when executed by processor 1140. The disclosed embodiments are not limited to separate programs or computers configured to perform dedicated tasks. For example, memory 1160 may include a single program that performs the functions of computing device 1110 or a program could comprise multiple programs. Additionally, processor 1140 may execute one or more programs, such as the exemplary platform applications disclosed herein. Memory 1160 may also store data that may reflect any type of information in any format that the system may use to perform operations consistent with the disclosed embodiments.

Processor(s) 1140 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in computing device 1110.

Interfaces 1180 may be one or more devices configured to allow data to be received and/or transmitted by computing device 1110. Interfaces 1180 may include one or more digital and/or analog communication devices that allow computing device 1110 to communicate with other machines and devices.

The foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments. For example, systems and methods consistent with the disclosed embodiments may be implemented as a combination of hardware and software or in hardware alone. Examples of hardware include computing or processing systems, including personal computers, laptops, mainframes, micro-processors and the like. Additionally, although aspects are described for being stored in memory, one skilled in the art will appreciate that these aspects can also be stored on other types of computer-readable media, such as secondary storage devices, for example, hard disks, floppy disks, or CD-ROM, or other forms of RAM or ROM.

Programmable instructions, including computer programs, based on the written description and disclosed embodiments are within the skill of an experienced developer. The various programs or program modules may be created using any of the techniques known to one skilled in the art or may be designed in connection with existing software. For example, program sections or program modules may be designed in or by means of C#, Java, C++, HTML, XML, CSS, JavaScript, or HTML with included Java applets. One or more of such software sections or modules may be integrated into a computer system or browser software or application.

In some embodiments disclosed herein, some, none, or all of the logic for the above-described techniques may be implemented as a computer program or application or as a plug-in module or subcomponent of another application. The described techniques may be varied and are not limited to the examples or descriptions provided. In some embodiments, applications may be developed for download to mobile communications and computing devices (e.g., laptops, mobile computers, tablet computers, smart phones, etc.) and made available for download by the user either directly from the device or through a website.

The foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

It is intended, therefore, that the specification and examples be considered as exemplary only. Additional embodiments are within the purview of the present disclosure and sample claims.

What is claimed is:

1. A computer-implemented method for scheduling events, the method comprising the following operations performed by at least one processor:
receiving an indication of a gesture via a multi-touch display of a computing device, wherein the indication of the gesture comprises data representing a starting location and data representing a directional vector;
identifying a first graphical object associated with the gesture;
displaying an event context menu in response to the received gesture;
receiving a selection of an event from the event context menu, the selected event corresponding to a second graphical object; and
displaying, on the multi-touch display, the second graphical object in place of the first graphical object to confirm the event selection.

2. The computer-implemented method of claim 1, further comprising:
determining an orientation of the computing device,
determining the directional vector for the input gesture based on the orientation of the computing device.

3. The computer-implemented method of claim 1, wherein the displayed event context menu is overlaid on the multi-touch display.

4. The computer-implemented method of claim 1, wherein the event selection corresponds to a calendar appointment.

5. The computer-implemented method of claim 1, further comprising:
identifying a plurality of first graphical objects associated with the gesture:
determining whether the plurality of first graphical objects are adjacent to one another;
determining a size for the second graphical object when the plurality of first graphical objects are determined to be adjacent to one another; and
replacing the plurality of first graphical objects with the second graphical object using the determined size for the second graphical object.

6. The computer-implemented method of claim 1, wherein the indication of the gesture comprises data representing a start time and an end time for the event selection.

7. The computer-implemented method of claim 6, further comprising:
retrieving a name for the selected event corresponding to the second graphical object; and
updating a plurality of fields with the start time, the end time, the duration, a graphical object representing the selected event, and the retrieved name for the selected event corresponding to the second graphical object.

8. The computer-implemented method of claim 1, further comprising:
determining whether the received gesture corresponds with a scheduled event;
determining whether the received gesture indication exceeds a minimum threshold;
if the gesture is determined to correspond to the scheduled event and exceeds the minimum threshold, enable the corresponding graphical object associated with the scheduled event to be responsive to gesture input; and
if the gesture is determined to correspond to the scheduled event and does not exceeds the minimum threshold, display the event context menu corresponding to the scheduled event.

9. The computer-implemented method of claim 8, wherein enabling the corresponding graphical object to be responsive to gesture inputs further comprises:
determining the number of corresponding graphical objects;
selecting the determined number of corresponding graphical objects; and
performing an gesture-related action to the selected graphical objects.

10. The computer-implemented method of claim 1, wherein the indication of the gesture comprises data representing at least one participant for the event.

11. The computer-implemented method of claim 1, wherein displaying the second graphical object in place of the first graphical object comprises replacing the first graphical object with the second graphical object,

12. The computer-implemented method of claim 1, wherein displaying the second graphical object in place of the first graphical object comprises overlaying the second graphical object over the first graphical object.

13. A system for scheduling an event, the system comprising:
at least one processor;
a memory device that stores a set of instructions which, when executed by the at least one processor, causes the at least one processor to:
receive an indication of a gesture via a multi-touch display of a computing device, wherein the indication of the gesture comprises data representing a starting location and data representing a directional vector;
identify a first graphical object associated with the gesture;
display an event context menu in response to the received gesture;
receive a selection of an event from the event context menu, the selected event corresponding to a second graphical object; and
display, on the multi-touch display, the second graphical object in place of the first graphical object to confirm the event selection.

14. The system in claim 13, further comprising instructions which, when executed by the processor, cause the processor to:
determine an orientation of the computing device,
determine the directional vector for the input gesture based on the orientation of the computing device.

15. The system in claim 13, wherein the displayed event context menu is overlaid on the multi-touch display.

16. The system in claim 13, wherein the event selection corresponds to a calendar appointment.

17. The system in claim 13, further comprising instructions which, when executed by the processor, cause the processor to:
identify a plurality of first graphical objects associated with the gesture;
determine whether the plurality of first graphical objects are adjacent to one another;
determine a size for the second graphical object when the plurality of first graphical objects are determined to be adjacent to one another; and
replace the plurality of first graphical objects with the second graphical object using the determined size for the second graphical object.

18. The system in claim 13, wherein the indication of the gesture comprises data representing a start time and an end time for the event selection.

19. The system in claim 13, further comprising instructions which, when executed by the processor, cause the processor to:
retrieve a name for the selected event corresponding to the second graphical object; and
update a plurality of fields with the start time, the end time, a graphical object representing the selected event, and the retrieved name for the selected event corresponding to the second graphical object.

20. The system in claim 13, further comprising instructions which, when executed by the processor, cause the processor to:
determine whether the received gesture corresponds with a scheduled event;
determine whether the received gesture indication exceeds a minimum threshold;
if the gesture is determined to correspond to the scheduled event and exceeds the minimum threshold, enable the corresponding graphical object associated with the scheduled event to be responsive to gesture input; and
if the gesture is determined to correspond to the scheduled event and does not exceeds the minimum threshold, display the event context menu corresponding to the scheduled event.

21. The system in claim 20, further comprising instructions which, when executed by the processor, cause the processor to:
determine the number of corresponding graphical objects;
select the determined number of corresponding graphical objects; and
perform an gesture-related action to the selected graphical objects.

22. The system in claim 13, wherein the indication of the gesture comprises data representing at least one participant for the event.

23. The system in claim 13, wherein displaying the second graphical object in place of the first graphical object comprises replacing the first graphical object with the second graphical object.

24. The system in claim 13, wherein displaying the second graphical object in place of the first graphical object comprises overlaying the second graphical object over the first graphical object.

25. The computer-implemented method for manipulating a timeline, the method comprises the following operations performed by at least one processor:
displaying, on a multi-touch display, a plurality of content areas, each content area corresponding to a starting graphical object and an associated amount of time;
receiving an indication of a pinch or spread gesture via the multi-touch display, the indication of the pinch or spread gesture comprising data representing a first location and a first direction, wherein a first set of graphical objects comprises first plural graphical objects fully displayed on the multi-touch display, and wherein a second set of graphical objects comprises second plural graphical objects depicting time not yet displayed on the multi-touch display; and
updating the content area corresponding to the starting graphical object to depict the time to display the second set of graphical objects.

26. The computer-implemented method of claim 25, further comprising:
determining whether the first direction is toward or away from the first location;
if the first direction is determined to be toward the first location, the updated content area decreases the viewable range; and
if the first direction is determined to be away from the first location, the updated content area increases the viewable range.

27. The computer-implemented method of claim 25, wherein the first plural graphical objects correspond to at least one of minutes, days, weeks, months, or years.

28. The computer-implemented method of claim 25, wherein the second plural graphical objects correspond to at least one of minutes, days, weeks, months, or years.

29. A system for manipulating a timeline via a gesture, the system comprising:
at least one processor;
a memory device that stores a set of instructions which, when executed by the at least one processor, causes the at least one processor to:
displaying, on a multi-touch display, a plurality of content areas, each content area corresponding to a starting graphical object and an associated amount of time;
receiving an indication of a pinch or spread gesture via the multi-touch display, the indication of the pinch or spread gesture comprising data representing a first location and a first direction, wherein a first set of graphical objects comprises first plural graphical objects fully displayed on the multi-touch display, and wherein a second set of graphical objects comprises second plural graphical objects depicting time not yet displayed on the multi-touch display; and
updating the content area corresponding to the starting graphical object to depict the time to display the second set of graphical objects.

30. The system in claim 29, further comprising instructions which, when executed by the processor, cause the processor to:
determine whether the first direction is toward or away from the first location;
if the first direction is determined to be toward the first location, the updated content area decreases the viewable range; and
if the first direction is determined to be away from the first location, the updated content area increases the viewable range.

31. The system in claim 29, wherein the first plural graphical objects correspond to at least one of minutes, days, weeks, months, or years.

32. The system in claim 29, wherein the second plural graphical objects correspond to at least one of minutes, days, weeks, months, or years.

33. A computer-implemented method for updating a graphical object associated with a scheduled event, the method comprises the following operations performed by at least one processor:
scheduling an event, the event being associated with a start time;
displaying at least one graphical object corresponding to the event, the at least one graphical object being displayed in at least one color; and
updating, progressively, the at least one color of the at least one graphical object as the current time approaches the start time of the scheduled event.

34. The computer-implemented method of claim 33, further comprising:
determining the difference in time between the current time to the start time; and
dynamically refreshing, based on the determined difference in time, the at least one color of the graphical object.

35. A system for updating a graphical object, the system comprising:
at least one processor;
a memory device that stores a set of instructions which, when executed by the at least one processor, causes the at least one processor to:
schedule an event, the event being associated with a start time;
display at least one graphical object corresponding to the event, the at least one graphical object being displayed in at least one color; and
update, progressively, the at least one color of the at least one graphical object as the current time approaches the start time of the scheduled event.

36. The system of claim 35, further comprising instructions which, when executed by at least one processor, cause the at least one processor to:
determine the difference in time between the current time to the start time; and
dynamically refresh, based on the determined difference in time, the at least one color of the graphical object.

37. A computer-implemented method for scheduling events with at least one participant, the method comprising the following operations performed by at least one processor:
receiving an indication of a gesture via a multi-touch display of a computing device, wherein the indication of the gesture comprises data representing a starting location and data representing a directional vector;
identifying a first graphical object and the at east one participant associated with the gesture;
displaying an event context menu in response to the received gesture;
receiving a selection of an event from the event context menu, the selected event corresponding to a second graphical object;
displaying, on the multi-touch display, the second graphical object in place of the first graphical object to confirm the event selection; and
generating a notification for the scheduled event including the at least one participant associated with the gesture.

38. A system for scheduling events for at least one participant, the system comprising:
at least one processor;
a memory device that stores a set of instructions which, when executed by the at least one processor, causes the at least one processor to:
receive an indication of a gesture via a multi-touch display of a computing device, wherein the indication of the gesture comprises data representing a starting location and data representing a directional vector;
identify a first graphical object and the at least one participant associated with the gesture;
display an event context menu in response to the received gesture;
receive a selection of an event from the event context menu, the selected event corresponding to a second graphical object;
display, on the multi-touch display, the second graphical object in place of the first graphical object to confirm the event selection; and
generate a notification for the scheduled event including the at least one participant associated with the gesture based.
